(19) United States
(12) Patent Application Publication
(10) Pub. No.: US 2006/0168230 A1
(43) Pub. Date: Jul. 27, 2006

(54) Estimating a required number of servers from user classifications

(76) Inventors: Frank S. Caccavale, Hopedale, MA (US); Sridhar C. Villapakkam, Grafton, MA (US)

Correspondence Address: RICHARD AUCHTERLONIE;NOVAK DRUCE & QUIGG, LLP, 1000 LOUISIANA, SUITE 5320, HOUSTON, TX, 77002, US

(21) Appl. No.: 11/044,507

(22) Filed: Jan. 27, 2005

(51) Int. Cl. G06F 15/16; G06F 15/173

(52) U.S. Cl. 709/226; 709/217

(57) ABSTRACT

Network computer users are classified in terms of levels of use of various application programs that require service from network servers. One or more data networks are monitored to determine average server demand per user for the various user classes and application programs. A server pool sizing calculator is programmed with these server demand parameters and the workload that can be handled per server. A system administrator estimates the number of new users in each class for the various application programs, and enters these estimated numbers into the sizing calculator together with a specified system utilization, and the sizing calculator computes the number of servers needed for servicing the new users.

### AUTHORIZATION PURSUANT TO 37 C.F.R. §1.17(e)

A portion of the disclosure of this patent document contains computer language listings and graphical interfaces all of which are subject to copyright protection. The copyright owner, EMC Corporation, has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to data networks, and more particularly to estimating the number of servers that would be required for servicing a group of users.

### BACKGROUND OF THE INVENTION

Data network technology permits a large number of diverse users to share economically a large number of commodity servers. There has been an ever-increasing user demand for data processing and storage capability. This demand has been met in part by an increase in the capability of each server and in part by the use of a larger number of commodity servers. The rapid increase in user demand and server capability, however, has made the job of capacity planning more difficult for system administrators.

The system administrator is often faced with the question of how many servers will be needed for servicing an increase in the number of users. Typically, the system administrator estimates how many servers will be needed based on current data and any desired change in server utilization. For example, the current data include the present number of users, the present number of servers, and the present utilization of the servers. For an incremental increase in the number of users, the required number of additional servers has been estimated by linear extrapolation from the current data. For example, EMC Corporation of Hopkinton, Mass., has offered a software tool for virus checking servers that collects data from a network to measure the workload of the virus checking servers, and that will calculate the number of additional virus checking servers that would be need for servicing a specified number of additional users.

In recent times, server pool sizing has often been needed for the creation of an entirely new network for a new business unit, or for replacement of an obsolete data network with an entirely new server technology. In these cases, the system administrator may not have any current data regarding the loading or performance characteristics of the servers to be used in the new network. Without current data regarding server loading or performance, the system administrator typically relies on performance claims of the server vendors in terms of the maximum number of users that can be served per server. Often there is a discrepancy between the performance claims by the server vendor and the actual number of users that can be served by the server.

### SUMMARY OF THE INVENTION

It has been discovered that one source of discrepancy with respect to server vendor performance claims is due to a heterogeneous user population. Therefore, the estimate of the required number servers often can be improved by classifying the users into sub-groups based on expected levels of server usage, and more particularly by classifying the users based on expected usage of specific kinds of application programs. This classification can be done with or without collection of actual data regarding user loading. For the case where no actual data have been or are able to be collected, an entirely synthetic workload can be estimated. For example, a synthetic workload for a user group not yet in existence can be estimated based on job descriptions of the users in the group, and specified by numbers of users in particular classifications. This permits a system administrator to perform server pool sizing and capacity planning prior to installation of any servers in a new server pool.

In accordance with a first aspect, the invention provides a method of estimating how many servers would be required for servicing a group of users. The method includes classifying the users into sub-groups based on expected levels of server usage to determine how many of the users are included in each of the sub-groups, and operating a digital computer to calculate an estimate of how many of the servers would be required for servicing the group of users based on how many of the users are included in each of the sub-groups.

In accordance with another aspect, the invention provides a method of estimating how many servers would be required for servicing a group of user. The method includes, for each of a plurality of levels of usage of each of a plurality of application programs, estimating how many of the users are expected to have each of the plurality of levels of usage of each of the plurality of application programs, and operating a digital computer to calculate an estimate of how many of the servers would be required for servicing the group of users based on the estimates of how many of the users are expected to have each of the plurality of levels of usage of each of the plurality of application programs.

In accordance with yet another aspect, the invention provides a digital computer for estimating how many servers would be required for servicing a group of users. The digital computer is programmed, for each of a plurality of levels of usage of the servers, inputting an estimate of how many of the users are expected to have each of the plurality of levels of usage of the servers. The computer is also programmed for calculating an estimate of how many of the servers would be required for servicing the group of users based on the estimates of how many of the users are expected to have each of the plurality of levels of usage of the server.

In accordance with still another aspect, the invention provides a digital computer for estimating how many servers would be required for servicing a group of users. The digital computer is programmed, for each of a plurality of levels of usage of each of a plurality of application programs, for inputting an estimate of how many of the users are expected to have each of the plurality of levels of usage of each of the plurality of application programs. The computer is also programmed for calculating an estimate of how many of the servers would be required for servicing the group of users based on the estimates of how many of the users are expected to have each of the plurality of levels of usage of each of the plurality of application programs

In accordance with yet another aspect, the invention provides a program storage device containing a program executable by a digital computer for estimating how many servers would be required for servicing a group of users. The program is executable by the digital computer for inputting an estimate, for each of a plurality of levels of usage of the servers, of how many of the users are expected to have each of the plurality of levels of usage of the servers, and for calculating an estimate of how many of the servers would be required for servicing the group of users based on the estimates of how many of the users are expected to have each of the plurality of levels of usage of the server.

In accordance with a final aspect, the invention provides a program storage device containing a program executable by a digital computer for estimating how many servers would be required for servicing a group of users. The program is executable by the digital computer for inputting an estimate, for each of a plurality of levels of usage of each of a plurality of application programs, of how many of the users are expected to have each of the plurality of levels of usage of each of the plurality of application programs, and for calculating an estimate of how many of the servers would be required for servicing the group of users based on the estimates of how many of the users are expected to have each of the plurality of levels of usage of each of the plurality of application programs.

### BRIEF DESCRIPTION OF THE DRAWINGS

Additional features and advantages of the invention will be described below with reference to the drawings, in which:

FIG. 1 is a block diagram of a data network including servers for serving client workstations operated by respective users;

FIG. 2 is a flowchart of a preferred server pool sizing methodology in accordance with an aspect of the invention;

FIG. 3 shows a plot of response time as a function of workload for a hypothetical generic anti-virus server:

FIG. 4 is a flowchart of a preferred server pool sizing calculator in accordance with an aspect of the invention;

FIG. 5 shows a first graphical interface of the preferred server pool sizing calculator for calculating a recommended number of servers for a specified server utilization and a specified number of users;

FIG. 6 shows a second graphical interface of a server pool sizing calculator for calculating a recommended number of servers for a specified server utilization, a specified number of “power”, a specified number of “normal” users, and a specified number of “casual” users; and

FIG. 7 shows a third graphical interface of a server pool sizing calculator for calculating a recommended number of servers for a specified server utilization, and for each of a multiplicity of application programs, a specified number of “power” users of the application program, a specified number of “normal” users of the application program, and a specified number of “casual” users of the application program.

While the invention is susceptible to various modifications and alternative forms, specific embodiments thereof have been shown in the drawings and will be described in detail. It should be understood, however, that it is not intended to limit the invention to the particular forms shown, but on the contrary, the intention is to cover all modifications, equivalents, and alternatives falling within the scope of the invention as defined by the appended claims.

### DETAILED DESCRIPTION OF THE PREFERRED EMBODIMENTS

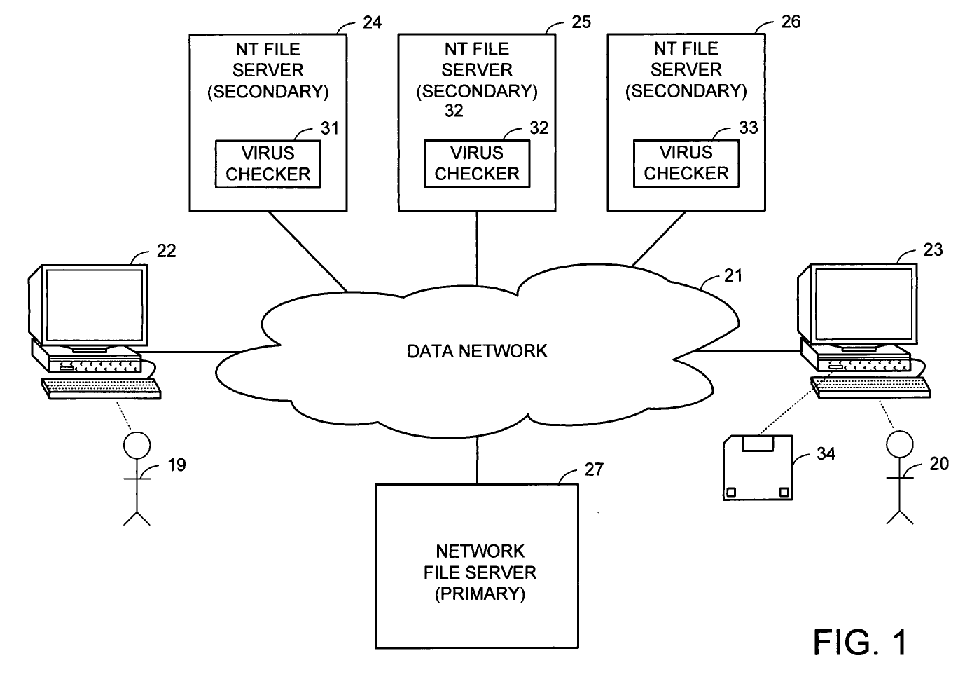

With reference to FIG. 1, there is shown a data processing system including a data network 21 interconnecting a number of clients and servers. The data network 21 may include any one or more of network connection technologies, such as Ethernet or Fibre Channel, and communication protocols, such as TCP/IP or UDP. The clients include work stations 22 and 23. The work stations, for example, are personal computers operated by human users 19, 20. The servers include conventional Windows NT/2000 file servers 24, 25, 26, and a very large capacity network file server 27. The network file server 27 functions as a primary server storing files in nonvolatile memory. The NT file servers 24, 25, 26 serve as secondary servers performing virus checking upon file data obtained from the network file server 27. The network file server 27 is further described in Vahalia et al., U.S. Pat. No. 5,893,140 issued Apr. 6, 1999, incorporated herein by reference. Such a very large capacity network file server 27 is manufactured and sold by EMC Corporation, 176 South Street, Hopkinton, Mass. 01748.

Each of the NT file servers 24, 25, 26 is programmed with a respective conventional virus checker 31, 32, 33. The virus checkers are enterprise class anti-virus engines, such as the NAI/McAfee's NetShield 4.5 for NT Server, Symantec Norton Anti-virus 7.5 Corporate Edition for Windows NT, or Trend Micro's ServerProtect 5.5 for Windows NT Server. In each of the NT file servers 24, 25, 26, the virus checker 31, 32, 33 is invoked to scan a file in the network file server 27 in response to certain file access operations. For example, when the file is opened for a user, the file is scanned prior to access by the user, and when the file is closed, the file is scanned before permitting any other user to access the file.

Further details regarding the operation of the virus checkers in the data processing system of FIG. 1 are described in Caccavale patent application US 2002/0129277 A1 published Sep. 12, 2002 and entitled “Using a Virus Checker in One File Server to Check for Viruses in Another File Server,” incorporated herein by reference.

The administrator of a data processing system is often faced with the question of how many servers will be needed to service an increase in the number of users. The system administrator can estimate the number of servers needed based on current data and any desired change in server utilization. For example, the current data include the present number of users, the present number of servers, and the present utilization of the servers. For an incremental increase in the number of users, the required number of additional servers has been estimated by linear extrapolation from the current data. For example, the current data can be collected from the network to measure the workload of the virus checking servers and the utilization of the virus checker servers as described in Caccavale et al. patent application US 2004/0236757 published Nov. 25, 2004 and entitled “Method and Apparatus Providing Centralized Analysis of Distributed System Performance Metrics,” incorporated herein by reference.

In some cases, a system administrator may want to estimate the number of servers required for network that has not yet been installed. In this case, it may be difficult or inappropriate to extrapolate from current data because the current data may not exist or the new user group or new server technology may be very different from the user group and server technology for which any current data are available. In this situation, the system administrator often has relied on the server vendor to supply an estimate of the number of users that can be served per server.

It has been discovered that calculation of the number of servers required to serve a specified number of users from an estimate of the number of users that can be served per server often is inaccurate since the user group may be heterogeneous in terms of the server workload per user. There may be a substantial variation in the server workload per user because of variation in the amount of time that each user spends each day working at his or her workstation and variation in the application programs that are used by each user. By classifying new users in terms of the amount of time that each user would spend during the busy hour each day working at his or her workstation and in terms of the application programs that would be used by each new user, it is possible to obtain a more precise estimate of the number of servers that would be required to serve the new users. This classification can be done with or without collection of actual data regarding loading by the new users. For the case where no actual user loading data have been or are able to be collected, an entirely synthetic workload can be estimated. For example, a synthetic workload for a user group not yet in existence can be estimated based on the proposed job descriptions of the users in the group, and specified by numbers of users in particular classifications.

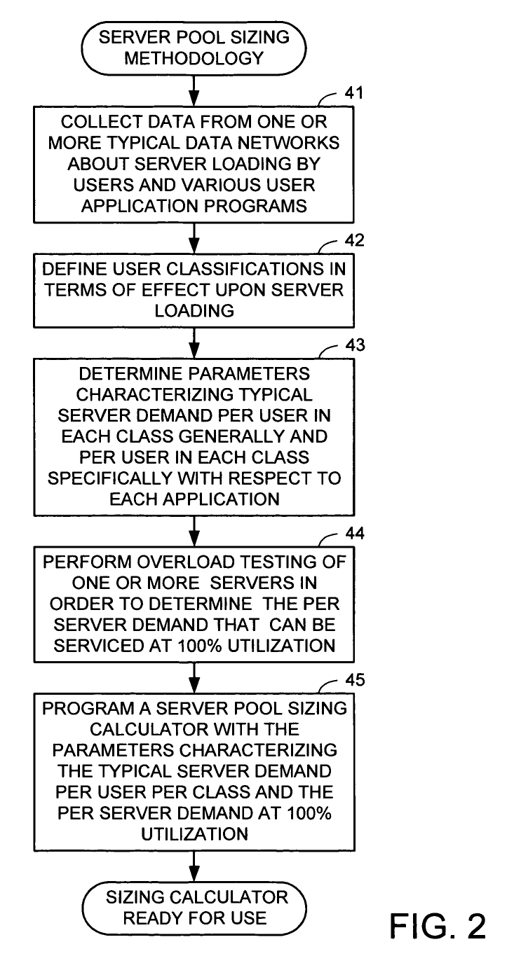

FIG. 2 shows a flowchart of a preferred server pool sizing methodology in accordance with an aspect of the invention. In a first step 41, data are collected from one or more typical data networks about server loading by users and various user application programs. For example, a busy hour during the day is identified, and during this busy hour, statistics are collected regarding the server loading per user generally and also specifically with respect to each of the user application programs. The server loading, for example, is measured during the busy hour in terms of server requests per user per second. The statistics, for example, include at least the average loading per user and the variance or standard deviation of this loading per user. Next, in step 42, user classifications are defined in terms of effect upon server loading. For example, the average loading per user and the variance or standard deviation of this loading per user are used to establish loading thresholds for classifying the users in terms of “power”, “normal”, and “casual” users, such that each class has about the same share of loading upon the server pool. In step 43, parameters are determined for characterizing typical server demand per user in each class generally and per user in each class specifically with respect to each application. This can be done by again collecting data from one or more typical networks and computing loading statistics including at least the average loading during the busy hour per user in each class generally and per user in each class specifically with respect to each application.

In step 44, overload testing of one or more servers is performed in order to determine the per server demand that can be serviced at 100% utilization. Each server request may have a different size in terms of data to be processed by the server, and this size on average may be dependent upon the particular application program originating or relating to the request. In this case, the overload testing could be performed by synthesizing requests having the same distribution of sizes as found during the collection of the data from the typical networks during the busy hour, or the overload testing could be done by recording the requests as they occur in the typical data networks during the busy hour, and by replaying the recorded requests at successively higher rates in order to overload one or more servers during the testing.

Finally, in step 45, a server pool sizing calculator is programmed with the parameters characterizing the typical server demand per user per class and the per server demand at 100% utilization. The server pool sizing calculator, for example, is implemented by programming a general purpose computer such as the workstation 23 in the data network of FIG. 1. In this case, the server pool sizing calculator program is an application program used by the system administrator 20. The server pool sizing calculator is initially stored on a program storage medium such as a floppy disk 34 that the system administrator inserts into a floppy disk drive in the workstation 23.

The server pool sizing methodology of FIG. 2 characterizes server capacity separately and independently of variations in server loading due to a heterogeneous user population. Therefore, if a new kind of server hardware or new version of server software becomes available, it can be tested in step 44 to reprogram the server pool sizing calculator with a new value of per server demand at 100% utilization for the new server without repeating steps 41 to 43 upon a network including the new kind of server. On the other hand, it is possible that even if there is no change in the kind of servers in a network, there might be a change over time in the typical server demand per user per class for the various application programs. For example, the characteristics of the application programs may change as they are updated from time to time by the application program vendors. Therefore, it may be desirable to repeat step 43 from time to time in order to update the server pool sizing calculator with new parameters characterizing the typical server demand per user per class.

In a preferred implementation of the present invention, the users are classified in terms of user activity as either power users, average users, or casual users. A power user is a person who is “on task” [application activities capable of generating anti-virus scans] forty or more minutes of the busy hour. Email activities are excluded because Email is scanned by special anti-virus software. A normal user is someone who is “on-task” between twenty and forty minutes of the busy hour. A casual user is someone who is “on-task” between one and twenty minutes of the busy hour. In this fashion, users of applications capable of generating anti-virus scans are classified into three groups in accordance with a first threshold (forty minutes per busy hour) that is greater than an average level of expected server usage and in accordance with a second threshold (20 minutes per busy hour) that is less than the average level of expected server usage, so that the first group (power users) includes users having an expected server usage that is greater than the first threshold, the second group (normal users) includes users having an expected server usage that is lower than the first threshold and greater than the second threshold, and the third group (casual users) includes users having an expected server usage that is lower than the second threshold.

In a preferred implementation of the present invention, the users are also classified separately with respect to each of a number of application programs as either power users, average users, or casual users of the application program. A power user of a particular application program is a person who is “on task” with respect to the application program forty or more minutes of the busy hour. A normal user is someone who is “on-task” with respect to the application program between twenty and forty minutes of the busy hour. A casual user is someone who is “on-task” with respect to the application program between one and twenty minutes of the busy hour.

In a preferred implementation, the collection and analysis of data about anti-virus server loading for various application programs as a function of user activity is done for a number of application program types by selecting a representative sample of applications which represent each application type. For instance, for the type “Word Processing” the applications Microsoft Word and Corel WordPerfect are selected as the representative application instances. A testing harness is wrapped around each application allowing for user simulation via scripting (including a facility for varying the rate at which user work is done). This allows for a “Word Processing User” to exercise a workload of the Word Processing type at different levels of use which correspond to “normal”, “power”, and “casual” word processing users. By capturing the arrival rates and response times of the anti-virus workload which is generated by the testing harness, the salient parameters of a “word processing workload” can be determined for each anti-virus vendor's product. These parameters constitute the characteristics of this application type and are persisted across various vendors and anti-virus platforms. This work results in a quantitative description of the aggregate application workload by type of application, in terms of the average number of anti-virus scans from the application type per interval (the interval being the busy hour).

A sample summary of Word Processing application type from experiments using Symantec, McAfee, Computer Associates, Sophos, and TrendMicro AV engines running on Windows 2000 platforms (2 Gb main memory, 2 Ghz frequency) is listed below:

```
#define NETBENCH_RATIO 10.000
      // netbench ratio: 1 netbench user == 10 real users
/* ******************* avg scans per sec per user when busy ***************** */
      // word processing users
#define SCANS_PER_SEC_WP_POWER_USER  4.0/NETBENCH_RATIO
#define SCANS_PER_SEC_WP_NORMAL_USER  1.1/NETBENCH_RATIO
#define SCANS_PER_SEC_WP_CASUAL_USER  0.4/NETBENCH_RATIO
#define SCANS_PER_INTERVAL_WP_POWER_USER
((SCANS_PER_SEC_WP_POWER_USER)*(DEFAULT_INTERVAL_SECS))
*DEFAULT_PERCENT_INTERVAL_BUSY
#define SCANS_PER_INTERVAL_WP_NORMAL_USER
((SCANS_PER_SEC_WP_NORMAL_USER)*(DEFAULT_INTERVAL_SECS))
*DEFAULT_PERCENT_INTERVAL_BUSY
#define SCANS_PER_INTERVAL_WP_CASUAL_USER
((SCANS_PER_SEC_WP_CASUAL_USER)*(DEFAULT_INTERVAL_SECS))
*DEFAULT_PERCENT_INTERVAL_BUSY
```

This work is repeated for each type of application over the busy hour, resulting in an average per-user workload of 0.0118 scans/sec, an average per power user workload of 0.0163 scans/sec, an average per normal user workload of 0.00468 scans/sec, an average per casual workload of 0.00124 scans/sec, and the following workload parameter set (in units of scans per user per second) for each application type:

| Application | Power Users | Normal Users | Casual Users |
|---|---|---|---|
| Word Processing | 0.0200 | 0.00550 | 0.00220 |
| Spreadsheet | 0.0250 | 0.00500 | 0.00150 |
| Database | 0.0450 | 0.0150 | 0.00150 |
| Graphics | 0.0135 | 0.00250 | 0.00100 |
| Developers | 0.00615 | 0.00255 | 0.00180 |
| Download | 0.00145 | 0.00050 | 0.00020 |
| Web | 0.00300 | 0.00175 | 0.00065 |

The word processing applications are programs such as Microsoft Word or Corel WordPerfect. The spreadsheet applications are programs such as Microsoft Excel or Lotus 1-2-3. The database applications are single-user database applications such as Microsoft Access. Multi-user databases such as Microsoft SQL Server or Oracle databases should not be scanned by the anti-virus servers. The graphics applications are graphics creation or publication tools such as Adobe Photoshop. The development applications are programs such as Microsoft Visual Studio. The download applications are FTP and HTTP file transfer programs such as Ipswitch WS_FTP or web browser download programs. The web applications are web browsing programs such as Microsoft Internet Explorer, Netscape Navigator, or Mozilla Firefox.

In the preferred implementation of the invention, anti-virus server characterization data about server performance as a function of loading are collected by laboratory testing of anti-virus scanning engines from Symantec, McAfee, Computer Associates, Sophos, and TrendMicro. The test data are combined to yield characteristic curves for a “generic” anti-virus engine representing a hypothetical facility which has the aggregate behavior of the products of these vendors over a range of platforms running the Microsoft Windows (2000, 2003) operating systems. For instance, for the Windows 2000 OS running on a 2 Ghz, 2 Gb main memory system the investigations yields data for a characteristic curve of response time as a function of workload “x” in units of anti-virus scans per second that can be fitted to a polynomial of the form:
RT(x)=y=2E−06x⁶−0.0003x⁵+0.0134x⁴−0.2916x³+2.8998x²−10.758x+26.996

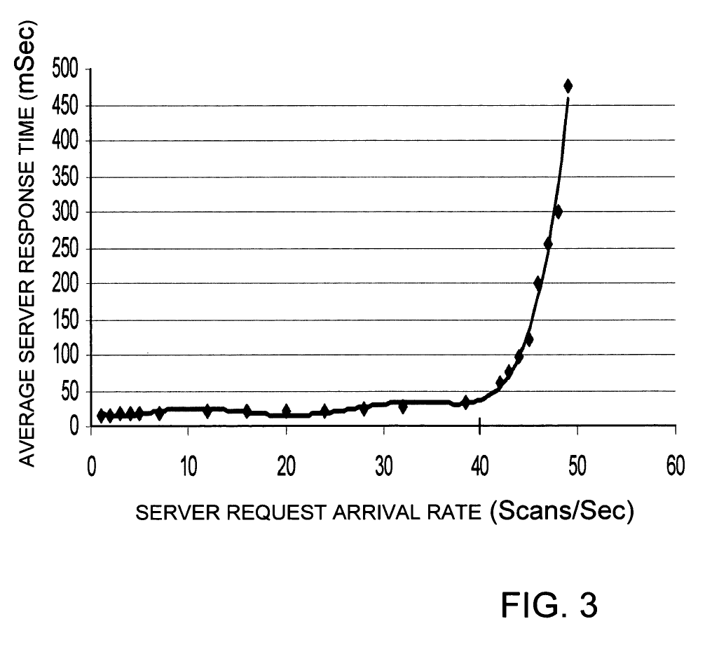

with a correlation coefficient of R2=0.9923, where “x” is in units of anti-virus scans per second. The data and the polynomial are plotted in FIG. 3.

Using the appropriate characteristic curve (based upon the anti-virus server platform-type), a saturation point for the scanning response time is calculated by finding the scan request arrival rate at the point where the characteristic curve begins to exhibit an exponential increase in scanning response time. For the generic characteristic curve in FIG. 2, for example, the saturation point for the scanning response time occurs for a scan arrival rate of about 40 scans per second.

The saturation point for a server characteristic curve can be located by the following computational procedure, given that the curve is defined by N workload/response time pairs (Wi, RTi) for i=1 to N. Calculate an average slope:
m_{avg}=(Wₙ−W₁)/(RTₙ−RT₁);
and then calculate n−2 local slopes, m₂−mₙ₋₁, where
m₂=(W₃−W₁)/(RT₃−RT₁)
and
mₙ₋₁=(Wₙ−Wₙ₋₂)/(RTₙ−RTₙ₋₂)
The saturation point is the one of the n points, x, which satisfies each of the following conditions mₓ=m_{avg}.+−0.5%; mₓ₋₁<=m_{avg}; and mₓ₊₁>m_{avg}.

Typically a condition of 100% utilization of a server occurs for a workload that can be satisfied by the server response time at the saturation point. In other words, the workload at 100% utilization is the reciprocal of the server response time at the saturation point. For the generic anti-virus server, the server response time at the saturation point is about 42 milliseconds. Therefore, a single generic anti-virus server can service about 24 anti-virus scans per second at a utilization of 100%.

In a preferred implementation of the present invention, a server pool sizing calculator is provided for use by a system administrator for calculating the required number of servers for servicing a specified heterogeneous user group. This sizing calculator is programmed with the parameters described above (e.g., an average number of server requests per second, the average number of server requests from the application programs collectively from each user class per second per user in the class for the application programs collectively, the average number of server requests from each application program from each user class per second per user in the class for the application program, and the maximum number of requests per second that can be handled by one server without overload).

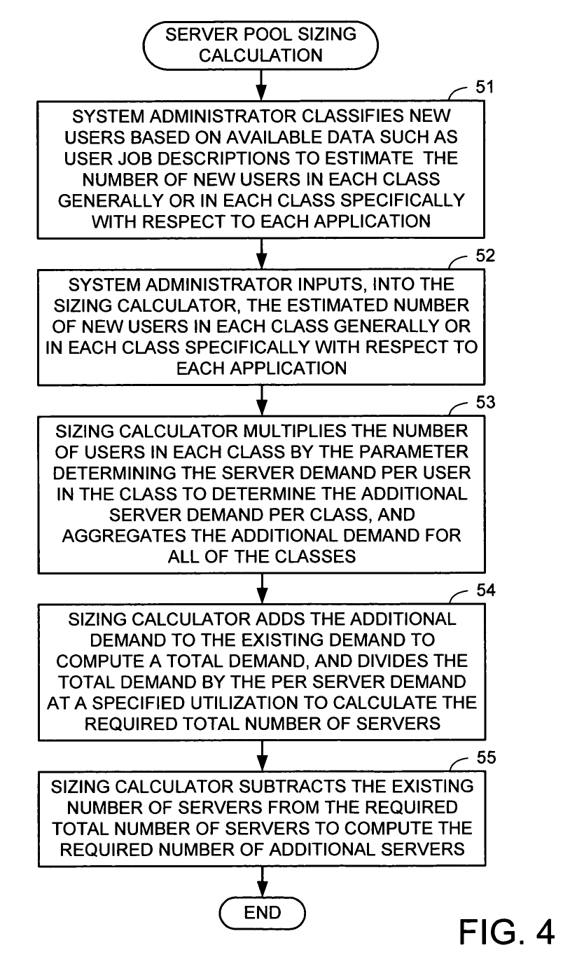

FIG. 4 shows the method of operation of the server pool sizing calculator. In a first step 51, the system administrator classifies new users based on available data such as user job descriptions to estimate the number of new users in each class generally or in each class specifically with respect to each application. In step 52, the system administrator inputs, into the sizing calculator, the estimated number of new users in each class generally or in each class specifically with respect to each application. In step 53, the sizing calculator multiplies the number of users in each class by the parameter determining the server demand per user in the class to determine the additional server demand per class, and aggregates the additional demand for all of the classes. For example, step 53 is performed by the following code:

```
/* Aggregate server demand from word processor users */
  dAvgScansPerInterval +=
(m_NumWPPowerUser*SCANS_PER_INTERVAL_WP_POWER_USER);
  dAvgScansPerInterval +=
(m_NumWPNormalUser*SCANS_PER_INTERVAL_WP_NORMAL_USER);
  dAvgScansPerInterval +=
(m_NumWPCasualUser*SCANS_PER_INTERVAL_WP_CASUAL_USER);
/* Aggregate server demand from spread sheet users */
  dAvgScansPerInterval +=
(m_NumSSPowerUser*SCANS_PER_INTERVAL_SS_POWER_USER);
  dAvgScansPerInterval +=
(m_NumSSNormalUser*SCANS_PER_INTERVAL_SS_NORMAL_USER);
  dAvgScansPerInterval +=
(m_NumSSCasualUser*SCANS_PER_INTERVAL_SS_CASUAL_USER);
/* Aggregate demand from data base users */
***
```

In step 54, the sizing calculator adds the aggregated additional demand to the existing demand to compute a total demand, and divides the total demand by the per server demand at a specified utilization to calculate the required total number of servers. This can be done by using the function “CalcRecServers” listed below in Appendix I. Finally, in step 55, the sizing calculator subtracts the existing number of servers from the required total number of servers to compute the required number of additional servers.

Depending on the network, each additional server added to the network typically will serve the same number of additional users, but it is quite possible that a network having a single server will serve a greater or lesser number of users than each additional server. For example, the first server in a network may perform general purpose functions in addition to a specific function such as anti-virus checking, and the additional servers may be dedicated to the specific function. Therefore, the additional servers may be different from the first server. It is also possible that a network having a single server can operate more efficiently than a network having multiple servers because when expanding a network from a single server to more than one server, there must be added processing overhead for distributing the server requests among the servers.

In the system of FIG. 1, for example, for supporting more than one anti-virus server, there is added processing overhead including thread manipulation on the network file server side, thread manipulation on the anti-virus server side, and anti-virus scan scheduling among the anti-virus servers. Therefore, the first generic anti-virus server can service up to about 36 anti-virus scanning requests per second, and each additional generic anti-virus server can service up to about 24 additional anti-virus scanning requests per second. For example, in the system of FIG. 1, one server can serve up to 3066 users, two servers can serve up to 5111 users, and three servers can serve up to 7155 users. In other words, a single server can serve 1.5 times as many users as each additional server. The function “CalcRecServers” listed below in Appendix I is programmed to reflect that a single server can serve 1.5 times as many users as each additional server by the constant of “0.500000” in the following statements:

```
if ( (dRecommendServers − lIntegerPart) >= 0.500000 )
{
    lRecommendNumServers++;
}
else
{
    lRecommendNumServers = lIntegerPart;
}
```

In a preferred implementation of the server pool sizing calculator, a system administrator selects one of three different graphical interfaces for entry of a specified user workload, depending on the scope of the system administrator's knowledge of the number and type of users and applications.

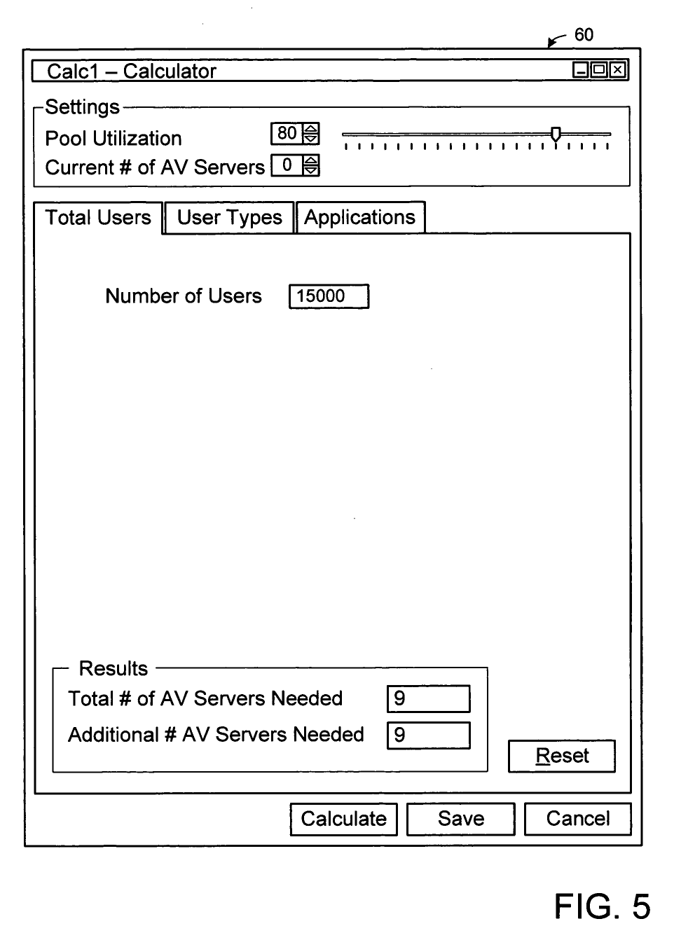

As shown in FIG. 5, the first graphical interface 60 presents a view in which the system administrator simply provides a system utilization and a total number of users, and the calculator calculates a required number of servers to serve this total number of users at the specified system utilization based on the average user workload in terms of requests per second, and based on the server capacity in terms of the maximum number of requests per second that can be handled per server at the specified system utilization. Then the user clicks on a “CALCULATE” button at the bottom of the interface to calculate the total number of anti-virus servers needed, and the number of additional anti-virus servers needed. Therefore, the first graphical user interface estimates the required number of servers in a conventional fashion, without any specific knowledge of user behavior in the user group.

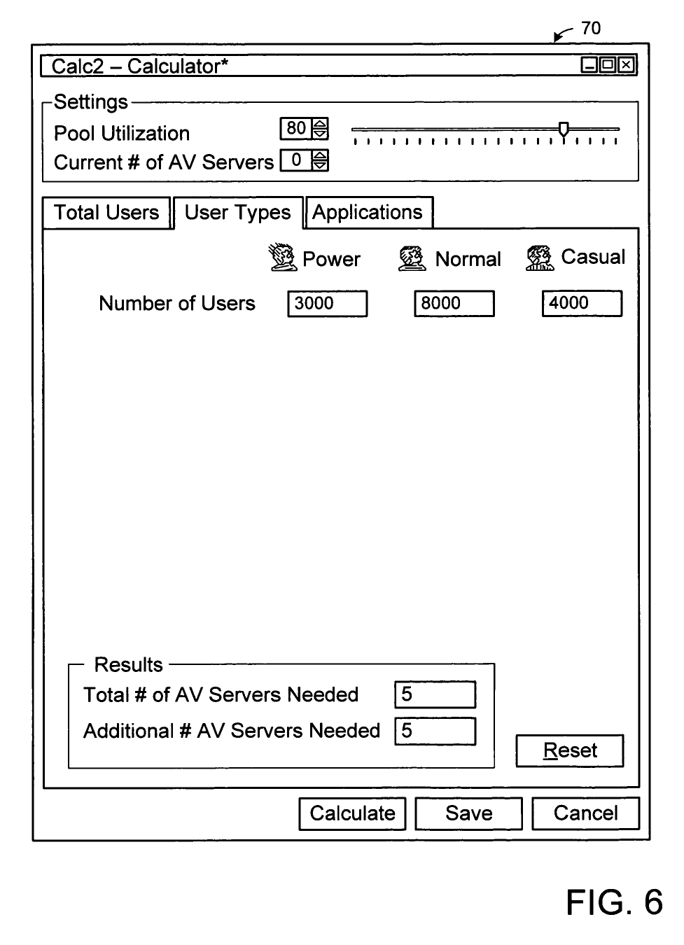

As shown in FIG. 6, the second graphical user interface 70 allows a system administrator to specify a heterogeneous user group by classification of the users by levels of average time on task. In particular, the system administrator specifies respective numbers of “power,” “normal,” and “casual” users. Then the user clicks on a “CALCULATE” button at the bottom of the interface to calculate the total number of anti-virus servers needed, and the number of additional anti-virus servers needed.

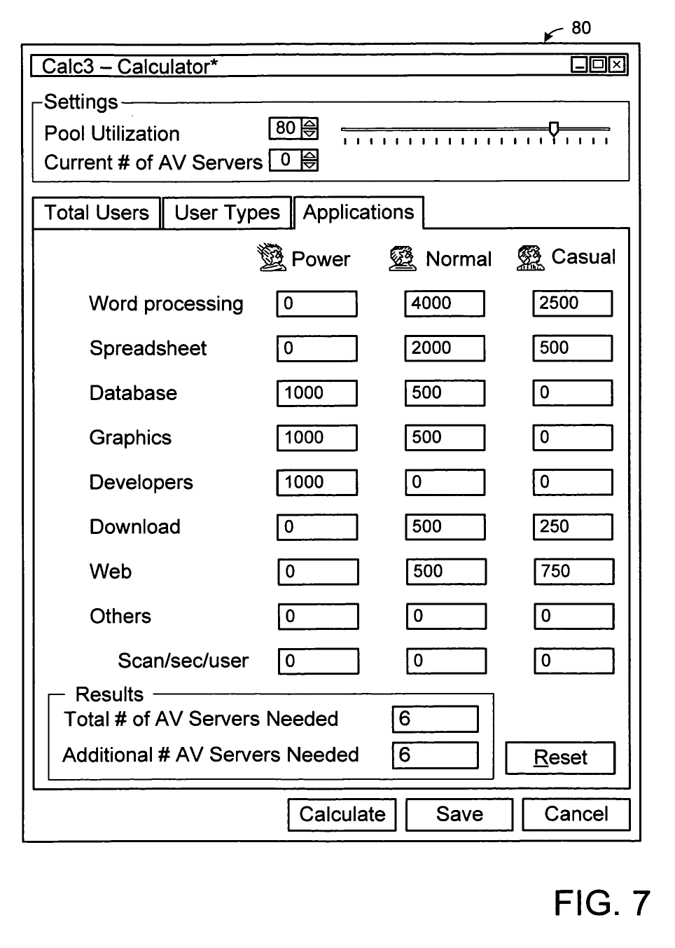

As shown in FIG. 7, the third graphical user interface 80 allows a system administrator to specify a heterogeneous user group in terms of applications used as well as levels of average time on task. For each application type, the system administrator specifies respective numbers of “power,” “normal,” and “casual” users of the application type, and then clicks on a “CALCULATE” button at the bottom of the interface to calculate the total number of anti-virus servers needed, and the number of additional anti-virus servers needed. As the system administrator's level of knowledge of a user group increases, the input to the sizing calculator becomes more granular, and the estimate of the required number of servers becomes more accurate and reliable.

The third graphical user interface 80 includes a row of input for an application type of “Others”, and a row of input labeled “Scan/sec/user”. This permits a system administrator to enter the numbers of power, normal, and casual users of another group of applications, and to enter the respective average workload per user in terms of scans per second per user for each of the power, normal, and casual users of this other group of applications.

For each of the graphical user interfaces in FIGS. 5 to 7, the user may click on a RESET button at the lower right of the interface to clear the user input data. This will set the various numbers of users to zero. The user may click on a “SAVE” button at the bottom of the interface to save the current data to a file. The saved data can be recalled by opening the file from an application window for the calculator program. The user may click on a “CANCEL” button at the bottom right of the interface to close the graphical interface window and exit the sizing calculator program

In view of the above, there has been described a methodology for server pool sizing for heterogeneous user groups. In a preferred implementation, parameters relevant to server pool sizing calculations for any specified heterogeneous user group are obtained by monitoring one or more typical data networks in order to collect and analyze data about the server loading of various application programs as a function of user activity, and by collecting and analyzing server characterization data about server performance as a function of loading. For example, the server loading of the application programs as a function of user activity is measured for each application program in terms of server requests per second of user activity with respect to the application program, and server performance as a function of loading is measured in terms of average server response time as a function of server requests per second. The data about the server loading of the application programs as a function of user activity are analyzed collectively for all users and all application programs by determining an average user workload in terms of an average number of server requests per second. The data about the server loading of the application programs as a function of user activity are analyzed collectively for the application programs by classifying the user population by levels of usage of all of the application programs (e.g., power, normal, or casual), and for each user class, determining an average number of server requests from the application programs per second per user in the class. The data about the server loading of the application programs as a function of user activity are analyzed separately for each application program by classifying the user population by levels of usage of the application program (e.g., power, normal, or casual), and for each user class with respect to the application program, determining an average number of server requests from the application program per second per user in the class. The server characterization data about server performance as a function of loading are analyzed to determine the capacity of one server in terms of a maximum number of requests per second that can be handled by the server without overload. In this fashion, server capacity is characterized separately and independently of variations in server loading due to a heterogeneous user population.

There has also been described a server pool sizing calculator for use by a system administrator for calculating the required number of servers for servicing a specified heterogeneous user group. In a preferred implementation, this sizing calculator is programmed with the parameters described above (e.g., the average number of server requests per second, the average number of server requests from the application programs collectively from each user class per second per user in the class for the application programs collectively, the average number of server requests from each application program from each user class per second per user in the class for the application program, and the maximum number of requests per second that can be handled by one server without overload). The system administrator selects one of three different graphical interfaces for entry of a specified user workload, depending on the scope of the system administrator's knowledge of the number and type of users and applications. The first graphical interface presents a view in which the system administrator simply provides a total number of users, and the calculator calculates a required number of servers to serve this total number of users based on the average user workload in terms of requests per second, and based on the server capacity in terms of the maximum number of requests per second that can be handled by one server without overload. Therefore, the first graphical user interface estimates the required number of servers in a conventional fashion, without any specific knowledge of user behavior in the user group. The second graphical user interface allows a system administrator to specify a heterogeneous user group by classification of the users by levels of average time on task. In particular, the system administrator specifies respective numbers of “power,” “normal,” and “casual” users. The third graphical user interface allows a system administrator to specify a heterogeneous user group in terms of applications used as well as levels of average time on task. As the system administrator's level of knowledge of a user group increases, the input to the sizing calculator becomes more granular, and the estimate of the required number of servers becomes more accurate and reliable.

Appendix I.

Function for calculating the required number of servers given the existing number of servers, the size of the interval in seconds, the average number of scans per interval, and the average server response time at the saturation point:

```
long CalcRecServers( long lnumExistingServers,
            long secsPerSampleInterval,
            double avgScansPerInterval,
            double avgResponseTime)
  {
    long  lRecommendNumServers = 0, lIntegerPart;
    double dRecommendServers;
    double lamda, mu;
    double serviceTimeSecs;
    double util;
    double desiredUtil;
    // pick up user-defined target utilization, set in dialog box
    if ( dTargetUtilization == 0 )
    {
      desiredUtil = (double)DEFAULT_TARGET_UTILIZATION;
    }
    else
    {
      desiredUtil = dTargetUtilization;
    }
    if ( secsPerSampleInterval == 0 )
    {
      // arrival rate in scans/sec
      lamda = 0.000;
    }
    else
    {
      // arrival rate in scans/sec
      lamda = (double)avgScansPerInterval/
      (double)secsPerSampleInterval;
    }
    serviceTimeSecs = avgResponseTime/1000.000;  // convert ms
    to secs
    mu = 1/serviceTimeSecs;
    util = lamda/mu;
    dRecommendServers = (lamda/(mu*desiredUtil));
    lRecommendNumServers = (long)dRecommendServers;
    lIntegerPart = (long)dRecommendServers;
    if ( (dRecommendServers − lIntegerPart) >= 0.500000 )
    {
      lRecommendNumServers++;
    }
    else
    {
      lRecommendNumServers = lIntegerPart;
    }
    if ( lRecommendNumServers == 0 )
    {
      lRecommendNumServers = MIN_NUM_SERVERS;
    }
      return lRecommendNumServers;
```

What is claimed is:

1. A method of estimating how many servers would be required for servicing a group of users, the method comprising:
classifying the users into sub-groups based on expected levels of server usage to determine how many of the users are included in each of the sub-groups; and
operating a digital computer to calculate an estimate of how many of the servers would be required for servicing the group of users based on how many of the users are included in each of the sub-groups.

2. The method as claimed in claim 1, wherein a system administrator exercises personal judgment to perform the classifying of the users into sub-groups based on expected levels of server usage to determine how many of the users are included in each of the sub-groups.

3. The method as claimed in claim 1, wherein the classifying of the users into the sub-groups includes assigning the users to the sub-groups based on job descriptions of the users.

4. The method as claimed in claim 1, wherein the users are classified into three groups in accordance with a first threshold that is greater than an average level of expected server usage and in accordance with a second threshold that is less than the average level of expected server usage, so that the first group includes users having an expected server usage that is greater than the first threshold, the second group includes users having an expected server usage that is lower than the first threshold and greater than the second threshold, and the third group includes users having an expected server usage that is lower than the second threshold.

5. The method as claimed in claim 1, wherein at least some of the users are presently served in a data network, and the classifying of the users into the sub-groups includes collecting data from the data network about server usage, and analyzing the data collected from the data network to classify said at least some of the users.

6. The method as claimed in claim 1, wherein the users are classified into groups of users of respective application programs.

7. The method as claimed in claim 1, which includes, for each of a plurality of application programs, estimating how many of the users in the group of users have a specified one of a plurality of usage levels of said each of the plurality of application programs.

8. The method as claimed in claim 1, which includes operating a plurality of application programs to determine average server workload per user for users in each of the subgroups, and wherein the average server workload per user for users in each of the subgroups is used in the calculation of the estimate of how many of the servers would be required for servicing the group of users based on how many of the users are included in each of the sub-groups.

9. The method of claim 1, wherein:
the classifying of the users into subgroups includes, for each of a plurality of levels of usage of each of a plurality of application programs, estimating how many of the users are expected to have said each of the plurality of levels of usage of said each of the plurality of application programs; and
the operating of the digital computer to calculate an estimate of how many of the servers would be required for servicing the group of users based on how many of the users are included in each of the sub-groups includes operating the digital computer to calculate an estimate of how many of the servers would be required for servicing the group of users based on the estimates of how many of the users are expected to have said each of the plurality of levels of usage of said each of the plurality of application programs.

10. The method as claimed in claim 9, wherein at least some of the users are presently served in a data network, and the method includes collecting data from the data network about usage of the application programs, and wherein the data collected from the network about usage of the application programs is used for the estimating of how many of the users are expected to have said each of the plurality of levels of usage of said each of the plurality of application programs.

11. The method as claimed in claim 9, which includes operating a plurality of application programs to determine average server workload per user from each of the application programs for each of the plurality of levels of usage of said each of the plurality of application programs, and wherein the average server workload per user from each of the application programs for each of the plurality of levels of usage of said each of the plurality of application programs is used in the calculation of the estimate of how many of the servers would be required for servicing the group of users based on the estimates of how many of the users are expected to have said each of the plurality of levels of usage of said each of the plurality of application programs.

12. The method as claimed in claim 1, wherein:
the classifying of the users into subgroups includes, for each of three levels of usage of each of a plurality of application programs, estimating how many of the users are expected to have said each of the three levels of usage of said each of the plurality of application programs; and
the operating of the digital computer to calculate an estimate of how many of the servers would be required for servicing the group of users based on how many of the users are included in each of the sub-groups includes operating the digital computer to calculate an estimate of how many of the servers would be required for servicing the group of users based on the estimates of how many of the users are expected to have said each of the three of usage of said each of the plurality of application programs.

13. A program storage device containing a program executable by a digital computer for estimating how many servers would be required for servicing a group of users, said program being executable by the digital computer for:
for each of a plurality of levels of usage of the servers, inputting an estimate of how many of the users are expected to have said each of the plurality of levels of usage of the servers; and
calculating an estimate of how many of the servers would be required for servicing the group of users based on the estimates of how many of the users are expected to have said each of the plurality of levels of usage of the servers.

14. The program storage device as claimed in claim 13 in combination with a digital computer for executing the program contained in the program storage device.

15. The program storage device as claimed in claim 13, wherein the program includes an average server workload per user for said each of the plurality of levels of usage of the servers, and wherein the average server workload per user for said each of the plurality of levels of usage of the servers is used in the calculation of the estimate of how many of the servers would be required for servicing the group of users based on the estimates of how many of the users are expected to have said each of the plurality of levels of usage of the servers.

16. The program storage device as claimed in claim 15 in combination with a digital computer for executing the program contained in the program storage device.

17. A program storage device containing a program executable by a digital computer for estimating how many servers would be required for servicing a group of users, said program being executable by the digital computer for:
for each of a plurality of levels of usage of each of a plurality of application programs, inputting an estimate of how many of the users are expected to have said each of the plurality of levels of usage of said each of the plurality of application programs; and
calculating an estimate of how many of the servers would be required for servicing the group of users based on the estimates of how many of the users are expected to have said each of the plurality of levels of usage of said each of the plurality of application programs.

18. The program storage device as claimed in claim 17 in combination with a digital computer for executing the program contained in the program storage device.

19. The program storage device as claimed in claim 17, wherein the program includes an average server workload per user for said each of a plurality of levels of usage of each of a plurality of application programs, and wherein the average server workload per user for said each of a plurality of levels of usage of each of a plurality of application programs is used in the calculation of the estimate of how many of the servers would be required for servicing the group of users based on the estimates of how many of the users are expected to have said each of the plurality of levels of usage of said each of the plurality of application programs.

20. The program storage device as claimed in claim 19 in combination with a digital computer for executing the program contained in the program storage device.
